(19) United States
(12) Patent Application Publication
(10) Pub. No.: US 2007/0067174 A1
(43) Pub. Date: Mar. 22, 2007

(54) Visual comparison of speech utterance waveforms in which syllables are indicated

(75) Inventors: Ashish Verma, New Delhi (IN); Hitesh Kapoor, Haryana (IN)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/232,679

(22) Filed: Sep. 22, 2005

(51) Int. Cl. G10L 21/06

(52) U.S. Cl. 704/276

(57) ABSTRACT

Speech utterance waveforms are visually compared in which syllables are indicated, such as in color. A speech utterance from a first user and a corresponding speech utterance from a second user are recorded. The phones, or phonemes, of each speech utterance are segmented, and these phones are mapped to the syllables of the speech utterances. A waveform of each speech utterance is displayed, in which syllables of the words spoken in the speech utterance are indicated. The syllables of the words may be distinguished in different colors, such that the same color is used for the same syllable in both of the utterances. A specific color can also be used to specify the stress level of a syllable. The users may visually compare the waveforms to assist understanding of the differences in syllable stress patterns between the utterance of the first user and the corresponding utterance of the second user.

### FIELD OF THE INVENTION

The present invention relates generally to displaying speech utterance waveforms, and more particularly to displaying such speech utterance waveforms in which the individual syllables of the speech utterances are highlighted, such as in different colors.

### BACKGROUND OF THE INVENTION

An important aspect of learning a new language is learning the pronunciations of the words of the language. Speaking words with correct pronunciations allows a person to speak more like a native, and makes that person more understandable to other people. However, learning the correct pronunciations of words of a language can be difficult, even with the assistance of someone skilled in the language, such as a native speaker or a skilled teacher.

Computerized systems have been developed to assist people in correctly speaking a language. In particular, such systems can record users as they speak words of a language, and display waveforms of the users' speech utterances of these words. By visually comparing the waveforms of a student's speech utterances to the waveforms of a teacher's speech utterances of the same words, a student may be able to identify which words he or she is speaking improperly.

Current computerized systems at best only display the waveforms of a student's speech utterances and the corresponding waveforms of a teacher's speech utterances of the same words. A student may not have difficulty pronouncing all aspects of a given word, but may only have difficulty pronouncing some aspects of the word, such as certain syllables and their stress levels. In such instances, it can be difficult for the student to pinpoint what portions of a waveform of the student's speech utterances correspond to the syllable or syllables of the word with which the student is having difficulty.

For these and other reasons, there is a need for the present invention.

### SUMMARY OF THE INVENTION

The present invention relates generally to visually comparing speech utterance waveforms in which individual syllables are indicated (i.e., highlighted), such as in color. The individual syllables may also be labeled with their names. A method of one embodiment of the invention records a speech utterance from a first user and a corresponding speech utterance from a second user. The first user may be a student learning proper accenting of the syllables of words, while the second user may be capable of speaking this with proper accent. The phones, or phonemes, of each speech utterance are segmented, and these phones are mapped to the syllables of the speech utterances. Alternatively, the speech utterance may be segmented directly into syllables as well.

A waveform of each speech utterance is displayed, in which syllables of the words spoken in the speech utterance are indicated. For instance, the syllables of the words may be distinguished in different colors, such that the same color is used for the same syllable in both of the speech utterances. The users may then visually compare the waveforms to assist understanding of the differences in syllable, such as, for example, stress patterns, between the speech utterance of the first user and the corresponding speech utterance of the second user.

A system of the present invention includes a recording mechanism, a processing mechanism, and a display mechanism. The recording mechanism is to record a first speech utterance from a first user, and a second speech utterance from a second user. The speech utterance from the first or/and second user may be pre-recorded as well. Both the first and the second speech utterances have one or more syllables of one or more words. The processing mechanism in one embodiment of the invention is to segment one or more phones, or phonemes, of each speech utterance, and to map the phones of each speech utterance to the syllables of the words. The display mechanism is to display a first waveform and a second waveform corresponding to the two speech utterances, in which the syllables thereof are indicated, such as in color. Differences in the pronunciation of the syllables of the two speech utterances are thus discernable by visual comparison of the first and the second waveforms.

An article of manufacture of the invention includes a computer-readable medium and means in the medium. The computer-readable medium may be a recordable data storage medium, a modulated carrier signal, or another type of computer readable medium. The means is for displaying a first waveform corresponding to a first speech utterance, and a second waveform corresponding to a second speech utterance, in which syllables of the speech utterances are indicated. Corresponding syllables of the first and the second speech utterances are displayed as portions of the first and the second waveforms in identical colors.

Embodiments of the invention provide for advantages over the prior art. In particular, the different syllables of the speech utterances are indicated in the displayed waveforms. For instance, the waveform of a speech utterance of a word having three syllables may have a first portion corresponding to the first syllable displayed in a first color, a second portion corresponding to the second syllable displayed in a second color, and a third portion corresponding to the third syllable displayed in a third color. The waveform of a corresponding speech utterance may similarly have its three portions corresponding to the three syllables of the word displayed in the same three colors.

Therefore, a student and his or her instructor are able to easily visually compare the two waveforms to learn where the student's pronunciation of the word differs from the instructor's, on a syllable-by-syllable basis. These users do not have to guess which parts of the waveforms correspond to which syllables, since the syllables are indicated, such as highlighted and/or labeled, in the waveforms as displayed. Thus, a student can compare the two waveforms to learn the correct manner by which to pronounce a given word, and focus on the syllables of the word that the student is not properly pronouncing. Similarly, the instructor can compare the two waveforms to assess the progress of the student and provide him or her with meaningful feedback.

Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for displaying the waveforms of speech utterances in which syllables of the words of the utterances are indicated, according to an embodiment of the invention, and which is suggested for printing on the first page of the patent.

FIGS. 2A and 2B are diagrams illustratively depicting the performance of the method of FIG. 1, according to different embodiment of the invention.

FIG. 3 is a diagram depicting two example waveforms that are displayed in accordance with the method of FIG. 1, according to an embodiment of the invention.

FIG. 4 is a diagram of a system for displaying the waveforms of speech utterances in which syllables of the words of the utterances are indicated, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

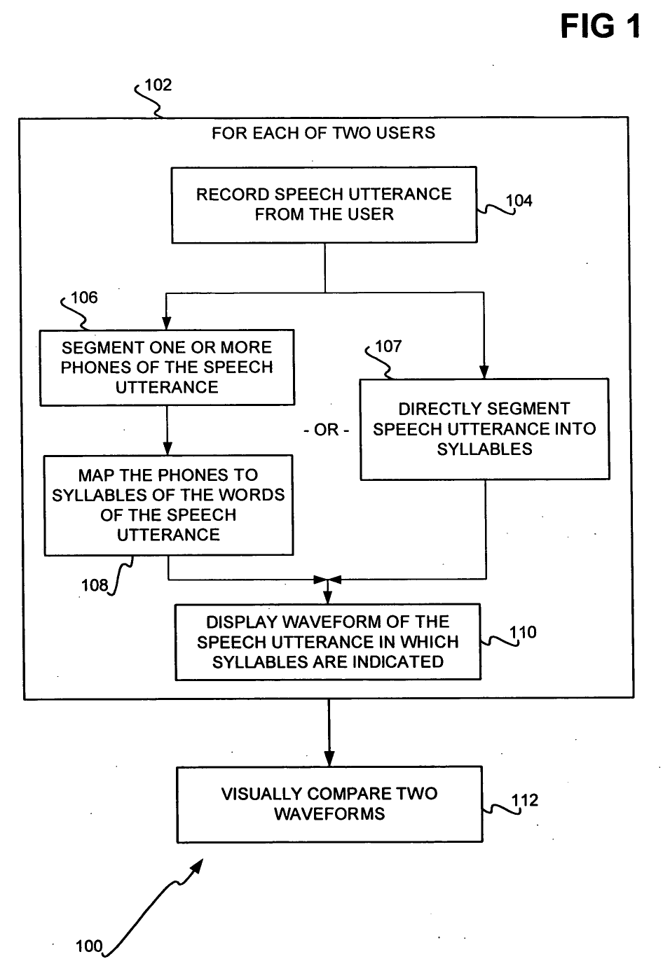

FIG. 1 shows a method 100 for displaying waveforms of speech utterances in which the syllables of the words of the utterances are indicated, such as in color, according to an embodiment of the invention. At least some parts of the method 100 may be implemented as computer program parts of a computer program stored on a computer-readable medium. The computer program parts may be subroutines, software objects, and other types of computer program parts. The computer-readable medium may be a volatile or a non-volatile medium, and may further be a semiconductor medium, a magnetic medium, and/or an optical medium, among other types of computer-readable media.

Parts 104, 106, 108, and 110 of the method 100 are performed for each of two users (102). One of the users may be a student learning the proper accenting of the syllables of words, while the other user may be capable of speaking with the proper accent the syllables of the words. For instance, the latter user may be an instructor, and/or a native speaker of the language that the student is attempting to learn.

A speech utterance of one or more words having one or more syllables is recorded from the user (104). The speech utterance may be recorded using a microphone or another type of recording device. The speech utterance is digitized in the recording process in one embodiment of the invention, so that the data representing the speech utterance may be processed and manipulated as described herein.

Next, either parts 106 and 108 of the method 100 are performed, or part 107 of the method 107 is performed. The parts 106 and 108 are first described, and then the part 107 is described. Thus, one or more phones, or phonemes, are segmented from the speech utterance recorded (106). The term phone is used interchangeably with the term phoneme for purposes of this patent application, even though the terms have different meanings with the art. For example, a phone is one of many possible sounds in the languages of the world, whereas a phoneme is a contrastive unit in the sound system of a particular language.

A phone is the smallest identifiable unit found within a stream of speech, whereas a phoneme is a minimal unit that serves to distinguish words. A phone is pronounced in a defined way, whereas a phoneme may be pronounced in one or more different ways. In general, a phone is a speech utterance, such as “k,” “ch,” and sh,” which is used to compose words, whereas a phoneme is the smallest phonetic unit within a language that is capable of conveying a distinction in meaning, such as the “b” of “bat” in English, as one example.

In one embodiment, the phones or phonemes of the speech utterance are segmented by performing a Viterbi alignment of the speech utterance, using one or more different speech recognition models, and employing a phonetic spellings database, in which words are spelled phonetically via their phones or phonemes. The Viterbi alignment process can be summarized as a problem of searching time boundaries for known sequences of hidden Markov models (HMM's) for phonemes. The best state sequence, which is known to be the Viterbi path, is obtained during the decoding process. The Viterbi alignment, or decoding, process is generally a way to decode convolutional codes, and this is useful and has been used in relation to segment the phones or phonemes of speech utterances.

Next, where the part 106 has been performed, the phones or phonemes of the speech utterance are mapped to the syllables of the words of the speech utterance (108), such as by using a syllabic mapping database. The syllabic mapping database maps groups of phones or phonemes to syllables, so that the phones or phonemes of the speech utterance that have been identified can be grouped together into syllables. In this way, by first segmenting the phones or phonemes of a speech utterance and then grouping sequences of the phones or phonemes into syllables, the syllables of the speech utterance are identified.

In another embodiment, the parts 106 and 108 of the method 100 are not performed, and instead the part 107 is performed. Thus, the speech utterance is directly segmented into its constituent syllables using one or more different speech recognition models and employing a syllabic spellings database (107). That is, in the parts 106 and 108, the phones of the utterance are segmented using speech recognition models and a phonetic spellings database, and then mapped to the syllables of the utterance. By comparison, in the part 107, the syllables of the utterance are instead directly segmented using speech recognition models and a syllabic spellings database, such that no phone-to-syllable mapping needs to be performed. It is noted that the speech recognition models employed in parts 106 and 108 may be phone-based models, whereas the speech recognition models employed in part 107 may be syllable-based models.

Finally, regardless of whether the parts 106 and 108, or the part 107, has been performed, the waveform of the speech utterance is displayed, in which the syllables are indicated (110). The waveform of the speech utterance is a digitized representation of the speech utterance as recorded. The segmentation of the phones of the speech utterance provides temporal boundaries of each phone within the utterance, which are then grouped together into distinct syllables of the speech utterance. As such, the syllables can be distinguished within the waveform of the speech utterance.

The syllables of the speech utterance are displayed within the waveform preferably in different colors. For example, a speech utterance may have three syllables. Therefore, the portion of the waveform corresponding to each syllable can be displayed in a different color. Because 110 is performed for each of two users, corresponding syllables between the speech utterances of the two users may be displayed in the same colors. For example, the portion of each waveform corresponding to the first syllable may be displayed in blue, the portion of the each waveform corresponding to the second syllable may be displayed in red, and so on. Furthermore, a specific color or colors may be used to specify the stressed syllable or syllables in a word, and other such enhancements may further be employed. For example, the primary stressed syllable may always be shown in red. In addition, the different syllables of the words may be labeled with their names.

Thus, the two waveforms of the speech utterances of the two users may be visually compared (112), to assist understanding of differences in the syllable stress patterns between the speech utterance of the first user and the speech utterance of the second user. The syllable stress pattern of a speech utterance is generally a combination of three speech attributes: pitch, energy (or loudness), and duration. When a syllable is given high stress, all of these attributes are greater or higher as compared to other syllables. Thus, for a multiple-syllable word, viewing the visual display of the waveform in which the syllables are indicated allows a user to quickly discern which syllable has been accented (stressed). Therefore, comparing two waveforms in which the syllables of the same word are indicated allows the user to determine if he or she is stressing the correct syllable as needed for proper speaking of a language.

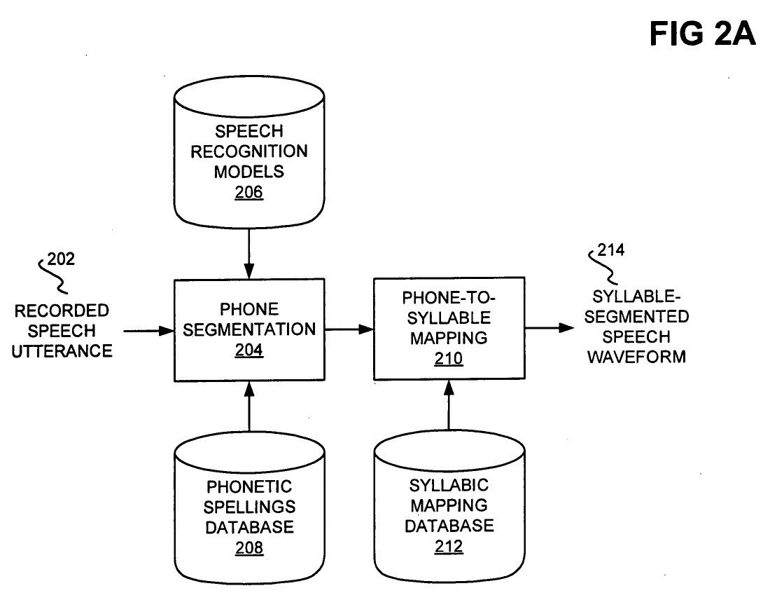

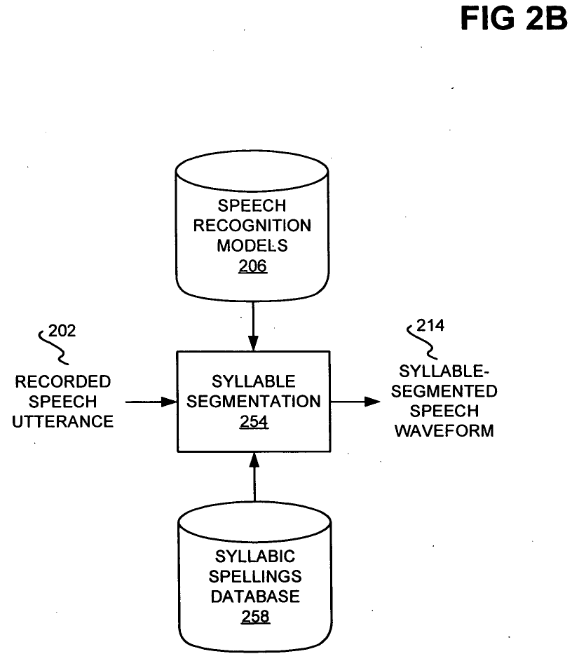

FIG. 2A shows a diagram illustratively depicting the performance of the method 100 of FIG. 1, according to an embodiment of the invention in which the parts 106 and 108 of the method 100 are performed instead of the part 107. The diagram of FIG. 2A is performed for each of two users, as in the part 102 of the method 100. A recorded speech utterance 202, as obtained in the part 104 of the method 100, is segmented into phones or phonemes, as indicated by the reference number 204, and as performed in the part 106 of the method 100. As has been described, the segmentation into phones or phonemes may be accomplished in one embodiment by performing a Viterbi alignment, using one or more speech recognition models 206, and a phonetic spellings database 208.

Once the recorded speech utterance 202 has been segmented into phones or phonemes, sequences of one or more phones or phonemes are mapped to syllables of the words of the speech utterance 202, as indicated by the reference number 210, and as performed in the part 108 of the method 100 of FIG. 1. As has been described, this mapping may be accomplished in one embodiment by using a syllabic mapping database 212 that maps different sequences of phones or phonemes to different syllables. The waveform 214 of the recorded speech utterance 202, in which the different syllables are indicated, such as in different colors, is then displayed, as performed in the part 110 of the method 100.

FIG. 2B shows a diagram illustratively depicting the performance of the method 100 of FIG. 1, according to an embodiment of the invention in which the part 107 of the method 100 is performed instead of the parts 106 and 108. The diagram of FIG. 2B is performed for each of two users, as in the part 102 of the method 100. A recorded speech utterance 202, as obtained in the part 104 of the method 100, is segmented directly into syllables, as indicated by the reference number 254, and as performed in the part 107 of the method 100. As has been described, the segmentation into syllables may be accomplished using one or more speech recognition models 206, and a syllabic spellings database 258. The waveform 214 of the recorded speech utterance 202, in which the different syllables are indicated, such as in different colors, is then displayed, as performed in the part 110 of the method 100.

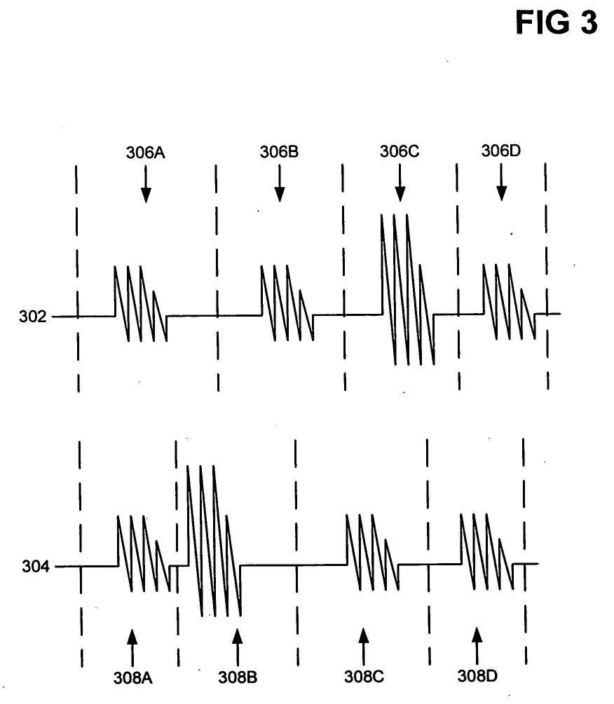

FIG. 3 shows two example waveforms 302 and 304 that may be displayed by performing the method 100 of FIG. 1, according to an embodiment of the invention. The waveforms 302 and 304 represent speech utterances of the same word by two different users. The waveform 302 has been divided into portions 306A, 306B, 306C, and 306D, collectively referred to as the portions 306, and that correspond to the different syllables of the word as uttered by the first user. The waveform 304 similarly has been divided into portions 308A, 308B, 308C, and 308D, collectively referred to as the portions 308, and that corresponds to the different syllables of the word as uttered by the second user.

Thus, the portions 306A and 308A correspond to the first syllable of the word, the portions 306B and 308B correspond to the second syllable of the word, the portions 306C and 308C correspond to the third syllable of the word, and the portions 306D and 308D correspond to the fourth syllable of the word. The portions 306 may be displayed in different colors, and the portions 308 may be displayed in the same different colors, as one way to indicate the syllables within the waveforms 302 and 304. For example, the portions 306A, 306B, 306C, and 306D may be displayed in red, blue, green, and yellow, respectively, whereas the portions 308A, 308B, 308C, and 308D may also be displayed in red, blue, green, and yellow, respectively.

As is evident in FIG. 3, the first user, speaking the word as represented by the waveform 302, is placing emphasis on, or is accenting, the third syllable, to which the portion 306C corresponds. This is because the portion 306C is larger or higher (or longer) than the other portions 306A, 306B, and 306D of the waveform 302. By comparison, the second user, speaking the same word as represented by the waveform 304, is placing emphasis on, or is accenting, the second syllable, to which the portion 308B corresponds. This is because the portion 308B is larger or higher (or longer) than the other portions 308A, 308C, and 308D of the waveform 304.

Visual comparison of the waveforms 302 and 304 thus can inform the first user that he or she is pronouncing the word in question incorrectly as compared to the second user. For instance, the first user may be the student of a language, and the second user may be a teacher of the language, such as a native speaker of the language. By comparing the waveforms 302 and 304, the student can easily conclude that he or she is accenting the third syllable, whereas the teacher is accenting the second syllable. Thus, embodiments of the invention allow users to determine which syllables of words they are accenting, as compared to another speaker of the same words.

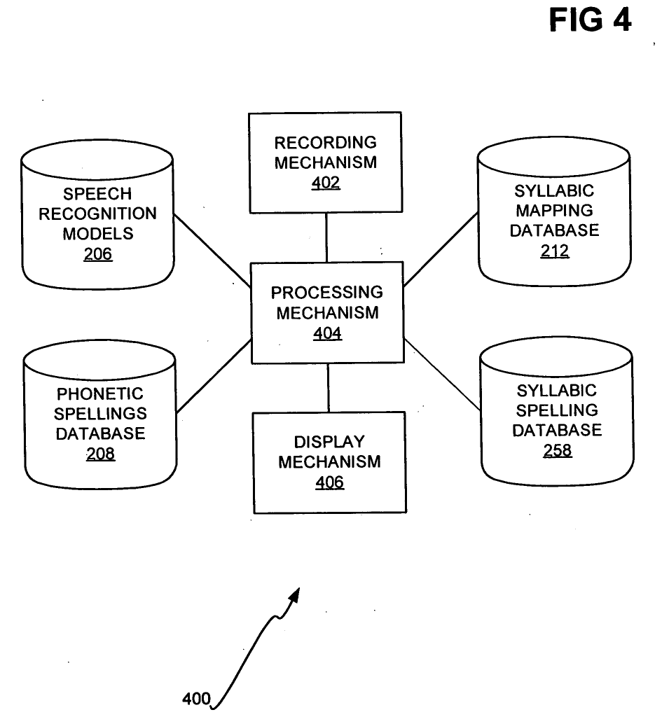

FIG. 4 shows a system 400 for performing the method 100 of FIG. 1, according to an embodiment of the invention. The system 400 includes a recording mechanism 402, a processing mechanism 404, and a display mechanism 406. The system 400 further includes the speech recognition models 206, the phonetic spellings database 208, the syllabic mapping database 212, and/or the syllabic spellings database 258 that have been described. As can be appreciated by those of ordinary skill within the art, the system 400 may include other components as well, in addition to and/or in lieu of those depicted in FIG. 4.

The recording mechanism 402 is hardware, such as a microphone, and records speech utterances from users. Thus, the recording mechanism 402 performs the part 104 of the method 100 of FIG. 1. The processing mechanism 404 is software, hardware, or a combination of hardware and software. The processing mechanism 404 in one embodiment segments phones or phonemes from the speech utterances recorded, and maps these phones or phonemes to syllables of the word or words spoken. Thus, the processing mechanism 404 performs the parts 106 and 108 of the method 100 in this embodiment, using the models 206 and the databases 208 and 212. In another embodiment, the processing mechanism 404 directly segments syllables from the speech utterances recorded, and thus performs the part 107 of the method 100, using the models 206 and the database 258.

The display mechanism 406 is hardware, such as a display device like a cathode-ray tube (CRT) or flat-panel display. The display mechanism 406 may further be a printing device, such as an inkjet or a laser printing device. The display mechanism 406 displays the waveforms of the speech utterances in which the syllables thereof are indicated, such as in color, as directed by the processing mechanism 404. As such, the display mechanism 406 performs the part 110 of the method 100 of FIG. 1. The display of the waveforms allows users to discern differences in pronunciations of the syllables of the speech utterances, by visual comparison of the waveforms, such that the part 112 of the method 100 is performed by the users.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

1. A method comprising:
receiving a speech utterance from a first user, the speech utterance having one or more syllables of one or more words;
displaying a waveform of the speech utterance in which the syllables of the speech utterance are indicated; and,
displaying a waveform of a corresponding speech utterance from a second user, in which one or more syllables of the corresponding speech utterance are indicated.

2. The method of claim 1, wherein receiving the speech utterance from the first user comprises receiving the speech utterance as prerecorded.

3. The method of claim 1, wherein receiving the speech utterance from the first user comprises recording the speech utterance from the first user.

4. The method of claim 1, further comprising:
segmenting one or more phones of the speech utterance; and,
mapping the phones of the speech utterance to the syllables of the speech utterance.

5. The method of claim 4, wherein segmenting the phones of the speech utterance comprises performing a Viterbi alignment of the speech utterance employing one or more speech recognition models.

6. The method of claim 4, wherein segmenting the phones of the speech utterance comprises employing a phonetic spellings database.

7. The method of claim 4, wherein mapping the phones of the speech utterance to the syllables of the speech utterance comprises employing a syllabic mapping database.

8. The method of claim 4, wherein displaying the waveform of the speech utterance comprises displaying portions of the waveform corresponding to the syllables in different colors.

9. The method of claim 1, further comprising directly segmenting the syllables of the speech utterance.

10. The method of claim 9, wherein directly segmenting the syllables of the speech utterance comprises employing a syllabic spellings database.

11. The method of claim 9, wherein directly segmenting the syllables of the speech utterance comprises employing one or more speech recognition models.

12. The method of claim 1, wherein the first user is a student learning proper accenting of the syllables of the words, and the second user is capable of speaking the proper accenting of the syllables of the words.

13. The method of claim 1, further comprising visually comparing the waveform of the speech utterance to the waveform of the corresponding speech utterance to assist understanding of differences in syllable stress patterns between the speech utterance of the words and the corresponding speech utterance of the words.

14. The method of claim 8, wherein displaying the waveform of the corresponding speech utterance comprises displaying portions of the waveform corresponding to the syllables in the different colors.

15. The method of claim 1, wherein displaying the waveform of the speech utterance comprise labeling different syllables of the words with names of the syllables.

16. A system comprising:
a recording mechanism adapted to record a first speech utterance from a first user and a second speech utterance from a second user, both the first and the second speech utterances having one or more syllables of one or more words;
a processing mechanism adapted to segment the syllables of each of the first and the second speech utterances; and,
a display mechanism adapted to display a first waveform of the first speech utterance in which the syllables thereof are indicated and to display a second waveform of the second speech utterance in which the syllables thereof are indicated,
such that differences in pronunciation of the syllables of the first and the second speech utterances are discernable by visual comparison of the first and the second waveforms.

17. The system of claim 16, wherein the processing mechanism is adapted to segment the syllables of each of the first and the second speech utterances by segmenting one or more phones of each of the first and the second speech utterances, and mapping the phones of each of the first and the second speech utterances to the syllables.

18. The system of claim 16, wherein the processing mechanism is adapted to segment the syllables of each of the first and the second speech utterances by directly segmenting the syllables of each of the first and the second speech utterances.

19. The system of claim 16, wherein the display mechanism is adapted to display portions of the first and the second waveforms in different colors corresponding to the syllables of the first and the second speech utterances, such that corresponding syllables of the first and the second speech utterances have corresponding portions of the first and the second waveforms displayed in identical colors.

20. An article of manufacture comprising:
a computer-readable medium; and,
computer code in the medium for displaying a first waveform corresponding to a first speech utterance and a second waveform corresponding to a second speech utterance in which syllables thereof are indicated, and in which corresponding syllables of the first and the second speech utterances are displayed as portions of the first and the second waveforms in identical colors.
